(19) United States
(12) Patent Application Publication
(10) Pub. No.: US 2002/0011404 A1
(43) Pub. Date: Jan. 31, 2002

(54) Seesaw-type power-supply switch device

(76) Inventors: Masayuki Takeda, Miyagi-ken (JP); Toshiharu Mori, Miyagi-ken (JP)

Correspondence Address: BRINKS HOFER GILSON & LIONE, P.O. BOX 10395, CHICAGO, IL, 60610, US

(21) Appl. No.: 09/836,853

(22) Filed: Apr. 17, 2001

(30) Foreign Application Priority Data
Apr. 18, 2000 (JP) 2000-122383

(51) Int. Cl. H01H 23/04

(52) U.S. Cl. 200/339

(57) ABSTRACT

A switch device includes a first case and a second case. Stationary contacts are enclosed within the first case that is sealed by a cover. An operating lever configured to actuate a movable contact is partially received by a window hole within the cover. An engaging hook is unitary part of or is coupled to the outside surface of the second case. Stationary terminals project from the stationary contacts. The second case encloses the first case and the cover. The first case and the cover are made of resins having an arc resistance. The second case is made of a thermoplastic resin that is more flexible than the first case.

### BACKGROUND

1. Field of the Invention

The present invention relates to a switch, and more particularly, to a seesaw-type power-supply switch.

2. Description of the Related Art

To mount some conventional switches to power supplies, the conventional switches engage an outer case of the power supplies through hooks. These hooks can be made of a flexible material, such as thermoplastic resin. When arc resistance is needed, the switch case can be made of a thermosetting resin. In some designs, the hooks are made of plate materials that connect to the switch case.

When a thermosetting resin is used, the hook, in some instance, is made separately from the switch case. In these switches, many parts can be needed and the parts can be difficult to assemble. Accordingly, there is a need for an easily assembled switch that has an arc resistance.

### SUMMARY

In one aspect of the invention, a switch comprises a first case and a second case. The first case has an accommodating portion that receives a stationary contact and a movable contact. A cover, having a window hole, is supported by a top portion of the first case. An operating lever that includes a portion passing through the window hole operates a movable contact. The movable contact mechanically couples and separates from a stationary contact. At an outside portion of the second case, a hook such as an engaging hook, and a stationary terminal project from the first case. The first case and the cover are received by the second case. In this aspect, the first case and the cover are comprised of an arc resistance resin. The second case is comprised of a thermoplastic resin. Preferably, the second case is more flexible than the first case. Furthermore, the stationary terminal is secured to the second case through a receiving hole by a press fitting. Preferably, the receiving hole passes through an inside bottom portion of the first case.

In a second aspect, a contact section, which comprises the stationary contact and the movable contact, is enclosed by the first case and the cover. An outside surface of the first case and an inside surface of the second case comprise a preventing means. A recess formed within an outside side surface of the first case, and a protrusion projecting from the inside surface of the second case preferably comprise the preventing means.

In another aspect, the switch comprises a protruding step which is positioned near an inside bottom surface of the second case. The protruding step is disposed near a hole configured to receive the stationary terminal. Preferably, a through hole passes through the inside bottom portion of the first case. The through hole is positioned to receive the protruding step. In this aspect, the stationary terminal is positioned within the switch by bringing a bottom surface portion of the stationary terminal into contact with the protruding step. In another aspect, the first case and the second case is positioned by fitting the protruding step through the through hole.

### BRIEF DESCRIPTION OF THE DRAWINGS

FIG. 1 is a front view of an embodiment of the invention.

FIG. 2 is a side view of FIG. 1.

FIG. 3 is a sectional view taken along lines III-III of FIG. 2.

FIG. 4 is a sectional view taken along line IV-IV of FIG. 2.

FIG. 5 is a plan view of a second case.

FIG. 6 is a front view of the second case.

FIG. 7 is a plan view of a first case.

FIG. 8 is a front view of the first case.

FIG. 9 is a plan view of a cover.

FIG. 10 is a front view of the cover.

FIG. 11 is a plan view of an operating lever.

FIG. 12 is a front view of the operating lever.

### DESCRIPTION OF THE PRESENTLY PREFERRED EMBODIMENTS

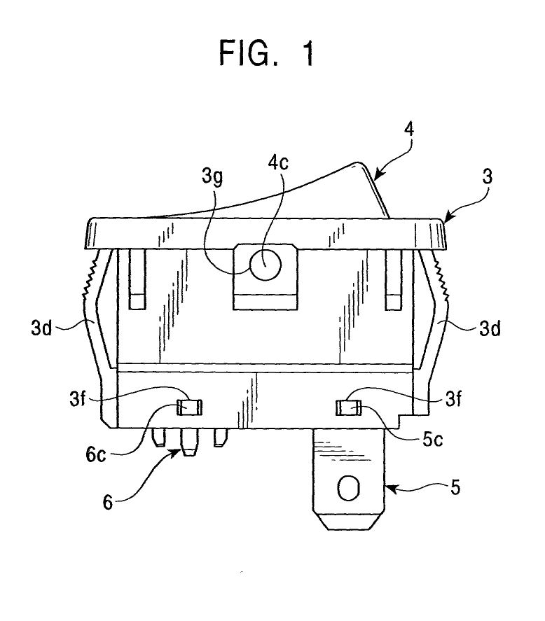

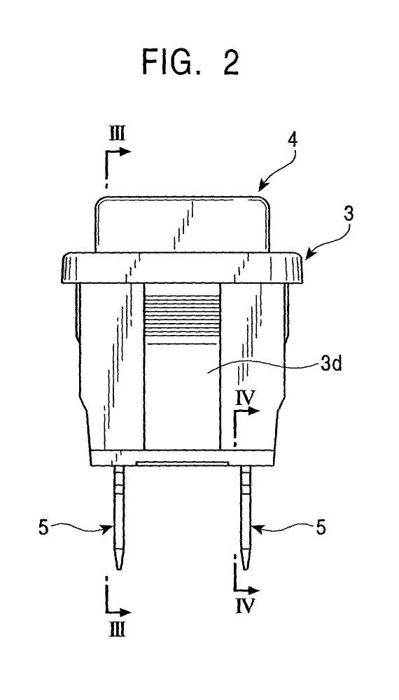

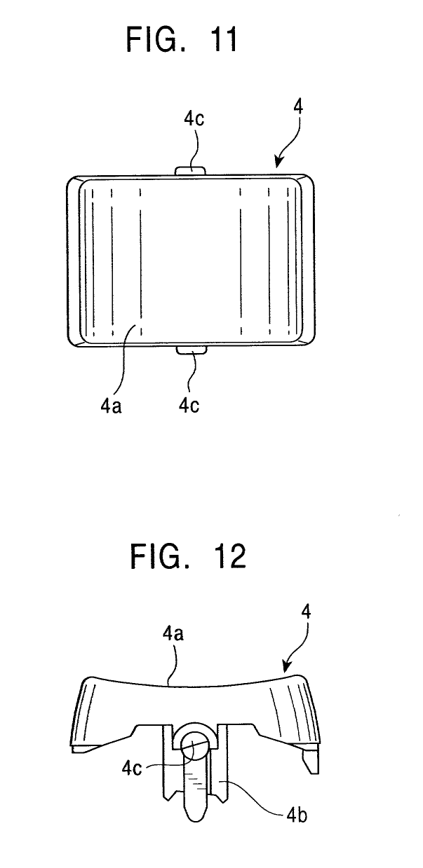

Referring to FIGS. 1-12, a first case 1 is comprised of an insulating material, that preferably includes a plastifiable PPS (polyphenylene sulfide) having an arc resistance and a thermosetting resin such as unsaturated polyester. Preferably, the plastifiable PPS has a high arc resistance.

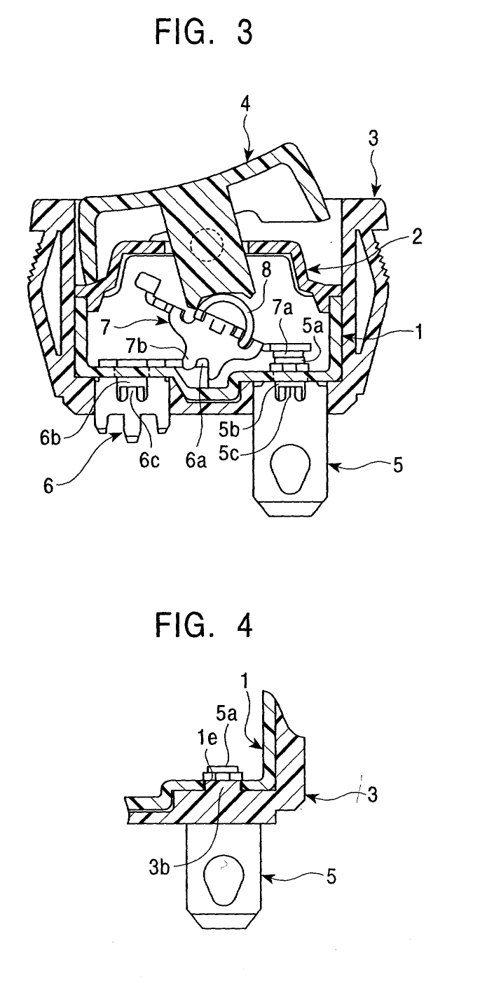

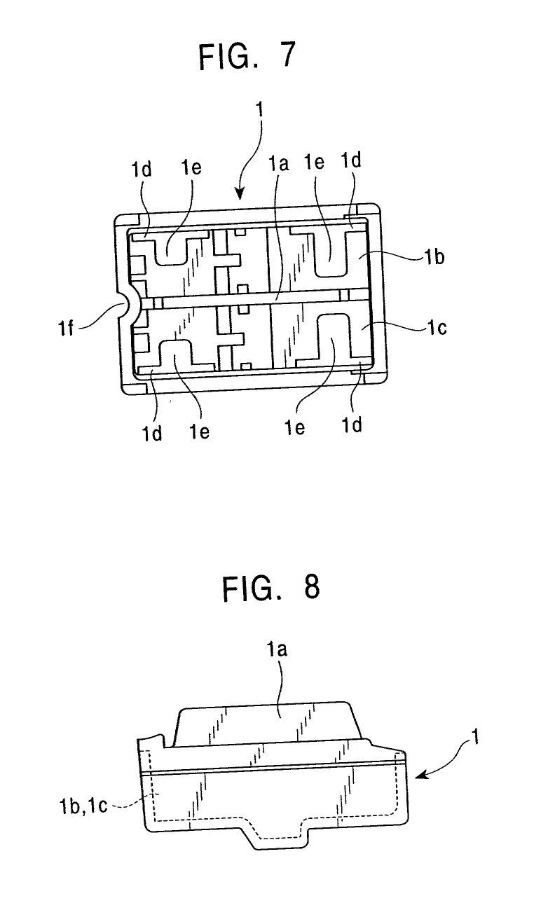

The first case 1 includes an open topside. As shown in FIG. 7, preferably an interior portion of the first case 1 is separated into two accommodating portions 1b and 1c by an insulating wall 1a. A pair of substantially rectangular slot-shaped receiving holes 1d are positioned near the corners of the first case 1. The substantially rectangular slot-shaped receiving holes 1d are configured to receive stationary terminals 5 and 6 that are shown in FIG. 3. The stationary terminals 5 and 6 are positioned in an interior bottom portion of the accommodating portions 1b and 1c. Preferably, the substantially rectangular slot-shaped receiving holes 1d are positioned across from each other. A pair of substantially rectangular or polygon shape through holes 1e are formed adjacent to each through hole 1d. These pairs of receiving holes 1d and through holes 1c are preferably positioned across from each other. As partially shown in FIG. 3, protruding steps 3b pass through and engage an inner peripheral surfaces of the corresponding through holes 1e.

As shown in FIG. 7, preferably, a recess 1f is formed in an outer surface end of the first case 1. The recess If is configured to receive a protrusion 3c which comprises an arc formed within an inside surface of the second case 3. In this embodiment, when the protrusion 3c and recess 1f are not in alignment, the first case 1 does not seat within the second case 3. This misalignment prevents the first case 1 from being properly coupled to the second case 3. Preferably, this misalignment is easily identified.

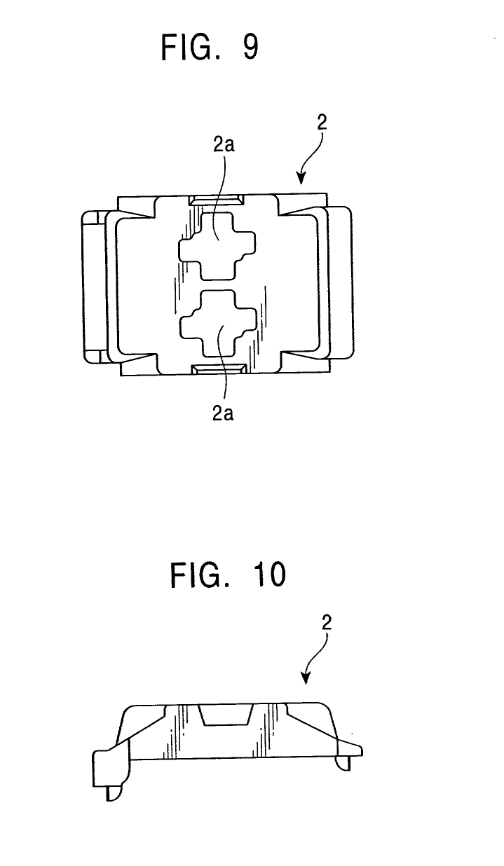

Preferably, a cover 2 comprises an insulating material such as a plastifiable PPS polyphenylene sulfide) having an arc resistance and a thermosetting resin such as unsaturated polyester. Preferably, the cover 2 has a substantially parallelepiped shape and an open bottom side. As shown in FIG. 9, a pair of cross-shaped window holes 2a pass through the the cover 2. An actuating portion 4b of an operating lever 4 shown in FIG. 12, passes through the pair of window holes 2a.

The cover 2 engages a top wall portion of the first case 1 to conceal the open portion of the first case 1. The first case 1 and the cover 2 are preferably configured to cover a contact section that comprises stationary contacts 5a and 6a and a movable contact 7 as shown in FIG. 3. In this embodiment, the contact section of the switch is protected by the cover 2 and the first case 1, which preferably comprise resins having high arc resistances.

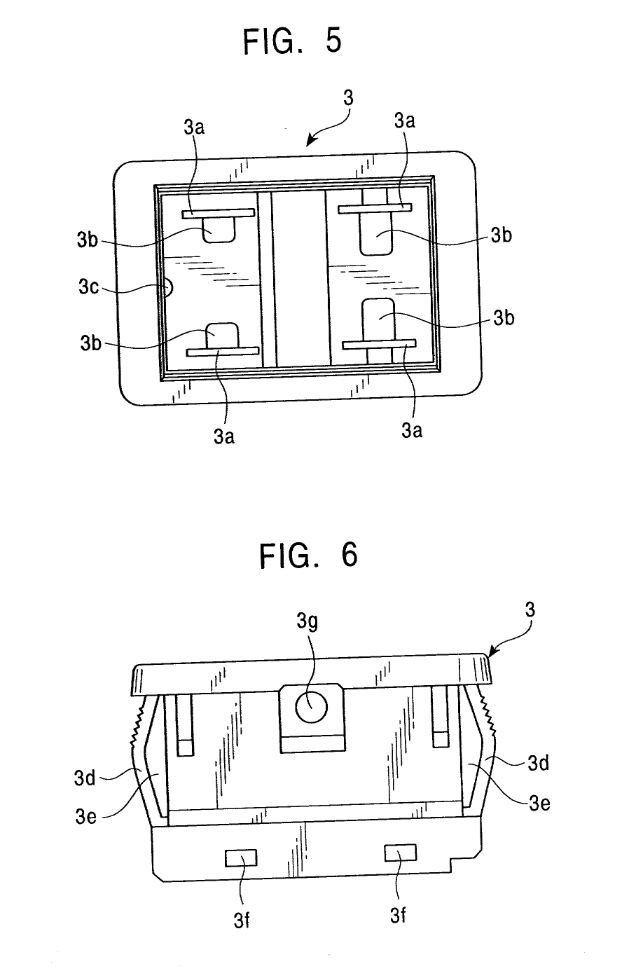

Preferably, the second case 3 is made of an insulating material, such as polyacetals and polyamides, which are thermoplastic resins that are more flexible than the first case 1. Preferably, the second case 3 has a substantially parallelepiped shape having an open top side. Two pairs of slot-shaped or polygonal shaped holes 3a for receiving the stationary terminals 5 and 6 pass through an inner bottom surface of the second case 3 shown in FIG. 5. The holes 3a are positioned across from each other. Two pairs of substantially rectangular or polygon shaped protruding steps 3b are formed near the holes 3a. The protruding steps 3b are positioned across from each other, and preferably pass through and engage the corresponding through holes 1e of the first case 1. In this embodiment, the heights of the protruding steps 3b are preferably slightly greater than the depths of the through holes 1e. The preferred heights of the protruding step 3b ensure that the protruding steps 3b pass through the corresponding through holes 1e. Preferably, the dimensions of the protruding step 3b allows the stationary terminals 5 and 6 that are secured to the holes 3a of the second case 3 to couple the protruding steps 3b. Accordingly, the stationary terminals 5 and 6 are mechanically coupled to the second case. Preferably, the protrusion 3c of the second case 3 is configured to engage the recess 1f of the first case 1. Preferably, the protrusion 3c is a unitary part of a side surface within the open portion of the second case 3. The protrusion 3c engages the recess 1f when the first case 1 is properly received by the second case 3. Preferably, the configuration of the outside surface of the first case 1 and the inside surface of the second case 3 prevents an improper assembly of the switch. If the first case 1 is improperly inserted within the second case 3, the recess 1f and the protrusion 3c will not engage each other and the first case 1 will not substantially seat within the second case 3. Accordingly, when the first case 1 has not been properly inserted within the second case 3, a misalignment is easily detected. The structure that prevents the first case 1 from being improperly inserted within the second case 3 is not limited to a recess and a protrusion because many other suitable structures may also be used.

As shown in FIG. 6, a hook, such as a preferred snap engaging hook 3d, for example, is a unitary part of or couples a side or a front surface of the exterior of the second case 3. Preferably, the hook 3d is made of a thin-plate material that terminates at ends coupled to or joined to the exterior surface of the second case 3. Preferably, the hook 3d is flexible, and encloses a substantially triangular or polygonal-shaped opening. The hook is preferably configured to snappingly engage devices, such as electronic devices.

As shown in FIG. 6, presser grooves 3f are positioned in the lower end of a front exterior surface of the second case 3. The presser grooves 3f are configured to press and inwardly bend dislodging-preventing pawls 5c and 6c after the stationary terminals 5 and 6 have been inserted through the holes 3a to prevent the stationary terminals 5 and 6 from becoming dislodged from the second case 3. Pawls 5c and 6c are formed on the bottom surface of the second case 3. The pawls 5c and 6c are disposed in a row that is coupled with the presser grooves 3f.

As partially shown in FIG. 1, preferably, holes 3g, which rotatably support shafts 4c of the operating lever 4, are formed near the top end of the second surface of the outside of the second case 3. Preferably, the operating lever 4 is made of an insulating material, such as synthetic resin. As partially shown in FIG. 12, preferably, the operating lever 4 comprises a substantially planar operating portion 4a, a rod-shaped actuating portion 4b, which couples the lower surface of the operating portion 4a, and a pair of the shafts 4c which oppose each other near the center of a side surface of the operating lever 4. Preferably, the actuating portion 4b is received by the pair of window holes 2a of the cover 2. Preferably, shafts 4c are received by the holes 3g and are supported by the second case 3 though which the holes 3g pass or partially pass through.

Preferably, a pair of the stationary terminals 5 and 6 are disposed near the inside bottom portions of the first and second cases 1 and 3. Preferably, the pair of stationary terminals 5 and 6 are made of electrically conductive materials, and are substantially L-shaped. The stationary contact 5a, with which a rotary contact portion 7a of the movable contact 7 engages, is preferably positioned near the top surface of the stationary terminal 5. The stationary contact 6a is preferably positioned near the top surface of the stationary contact 6. In this preferred embodiment, the stationary contact 6a is normally coupled to contact portion 7b.

The preferred dimensions of the receiving holes 1d of the first case 1 are preferably greater than the widths of the stationary terminals 5 and 6. The preferred dimensions of the holes 3a of the second case 3 are preferably slightly smaller than the receiving holes 1d. Ends of the stationary terminals 5 and 6 at sides opposite to the corresponding stationary contacts 5a and 6a pass through the receiving holes 1d of the first case 1. The ends of the stationary terminals 5 and 6 pass through the holes 3a of the second case 3 to press-fit and secure the stationary contacts 5a and 6a to the first and second case 1 and 3.

As shown in FIG. 3, preferably cutaway portions 5b and 6b pass through the centers of the stationary terminals 5 and 6. The dislodging-preventing pawls 5c and 6c are received by the cutaway portions 5b and 6b, respectively. The pawls 5c and 6c are disposed near the corresponding presser grooves 3f of the second case 3 shown in FIG. 6. The pawls 5c and 6c are pressed, and are inwardly bent to engage the presser grooves 3f and thereby prevent the stationary terminals 5 and 6 from becoming dislodged from the second case 3.

Preferably, the movable contact 7 comprises an electrically conductive material. The rotary contact portion 7a which contacts and separates from the stationary contact 5a is formed at a first end of the movable contact 7. The contact portion 7b which contacts the stationary contact 6a is formed at a second end of the movable contact 7. Preferably, a coil spring 8 rotatably biases the movable contact 7 as shown in FIG. 3. Preferably, the coil spring 8 is disposed near the center of the movable contact 7. The actuating portion 4b of the operating lever 4 preferably biases and rotates the coil spring 8, causing the movable contact 7 to rotate about the contact portion 7b like a fulcrum.

To assemble the preferred switch, the first case 1 is inserted into the second case 3. Preferably, the first case 1 is inserted into the bottom portion of the second case 3 such that the protrusion 3c engages the recess 1f. Preferably, the protruding step 3b of the second case 3 is received by the through holes 1e of the first case 1. Preferably the stationary terminals 5 and 6 are press-fit or inserted into the holes 3a of the second case 3 and through the receiving holes 1d of the first case 1. Through this engagement, the stationary terminals 5 and 6 are secured to the first and second cases 1 and 3. Preferably, the stationary terminals 5 and 6 are secured to the second case 3 through a pressing jig. Preferably the pressing jig press and bends the dislodging-preventing pawl 5c of the stationary terminal 5 and the dislodging-preventing pawl 6c of the stationary terminal 6.

Preferably, the movable contact 7 is disposed above the stationary terminals 5 and 6. In this embodiment, when the contact portion 7b is coupled or in contact with the stationary contact 6a, the cover 2 is coupled to the top portion of the first case 1, which is inserted within and secured to the second case 3. The actuating portion 4b of the operating lever 4 is inserted through the window holes 2a of the cover 2. Preferably an end of the actuating portion 4b is in contact the coil spring 8 which is disposed on the movable contact 7 when the shafts 4c of the operating lever 4 engage the holes 3g of the second case 3

According to the preferred embodiment, the switch device comprises a first case 1 and a second case 3. The first case 1 encloses the contacts 5a, 6a, and 7 within the first case 1. The cover 2 protects and seals the contacts 5a, 6a, and 7 from contaminants. Preferably, the engaging hook 3d and the stationary terminals 5 and 6 project from the second case which encloses the first case 1 and the cover 2. Preferably, the first case 1 and the cover 2 are made of resins having a high arc resistance.

Preferably, the second case 3 is made of a thermoplastic resin that is more flexible than the first case 1. The stationary terminals 5 and 6 are secured to the second case 3 by passing the stationary terminals 5 and 6 through the receiving holes 1d which pass through the inside bottom portion of the first case 1.

Preferably, the second case is made of a thermoplastic resin. The thermoplastic resin preferably provides arc resistances between the contacts, and forms the engaging hook 3d. Preferably terminals 5 and 6 are secured to the first and second cases 1 and 3, making it unnecessary to separately bond terminals to one or more cases through an adhesive. Moreover, to provide satisfactory arc resistance, the second case is preferably made of a thermosetting resin having a high arc resistance. Accordingly, the engaging hook 3d, in the preferred embodiment need not be made of a separate plate material.

The switch device of the preferred embodiment comprises a first case 1, a cover 2, and a second case 3. Preferably, the first case 1 comprises an accommodating portion in which stationary contacts 5a and 6a and the movable contact 7 are disposed. Preferably, the snap engaging hook 3d is a unitary part of or is coupled to the second case 3. The stationary terminals 5 and 6 project from the corresponding stationary contacts 5a and 6a. The second case 3 preferably encloses the first case 1 and the cover 2. Preferably, the first case 1 and the cover 2 are made of resins having an arc resistance, and the second case 3 is made of a more flexible resin than the first case 1.

In the preferred embodiment, the stationary terminals 5 and 6 are press-fitted to the second case 3. The stationary terminals 5 and 6 pass through the receiving holes id that pass through the inner bottom portion of the first case 1. Preferably, a high arc resistance between the contacts is maintained. The stationary terminals 5 and 6 can be press-fitted to the first and second cases 2 and 3. The preferred first and second case 2 and 3 and stationary terminals 5 and 6 make it unnecessary to separately bond the stationary terminal 5 and 6 to the cases 2 and 3 through an adhesive. The contact section, which comprises the stationary contacts 5a and 6a and the movable contact 7, may be enclosed by the first case 1 and the cover 2 which are made of resins having high arc resistances.

An outside surface of the first case 1 and an inside surface of the second case 3 may include a preventing means. Preferably, the preventing means prevent an assembly in which the first case 1 is improperly inserted into the second case 3. In a preferred embodiment, the preventing means comprises a recess 1f which is provided on the outside surface of the first case 1, and a protrusion 3c which is positioned on the inner surface of the second case 3. In this preferred embodiment, the recess 1f and the protrusion 3c are positioned on the sides of the respective first case 1 and second case 3 having the shortest lengths of each respective case. The preventing means can be integrally coupled or is a unitary part of the first and second cases 1 and 3. When the first case 1 is improperly inserted into the second case 3, the recess and the protrusion 3c are not aligned and thus, do not engage each other. This improper assembly can be easily detected because the first case 1 does not substantially seat within the second case 2.

The switch device may further comprise protruding steps 3b that are positioned on the inner bottom surface of the second case 3. The protruding steps 3b are preferably disposed near the holes 3a that receive the stationary terminals 5 and 6 and project upward from the inner bottom surface of the second case 3. Through holes 1e, passing through the inner bottom portion of the first case 1, receive the protruding steps 3b. In the preferred switch device, the stationary terminals 5 and 6 may be positioned by bringing bottom surface portions of the stationary terminals 5 and 6 into contact with the protruding steps 3b. Preferably, the stationary terminals 5 and 6 are received and secured to the holes 3a of the second case 3. The first case 1 and the second case 3 may be positioned by fitting the protruding steps 3b within the through holes 1e. Accordingly, the cases 1 and 3 can be easily aligned, and the receiving holes 3a and 1e can be easily aligned.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A switch device comprising:
a stationary contact;
a movable contact in switchable contact with the stationary contact;
a first case enclosing the stationary contact and the movable contact;
a cover having a window hole, the cover enclosing the first case;
an operating lever passing through the window hole, the operating lever being configured to actuate the movable contact;
a second case enclosing the first case and the cover, the second case having an engaging hook coupled to an outside surface of the second case;
a stationary terminal projecting from the stationary contact and the first and the second case;
wherein the first case and the cover are made of an arc resistance resin;
wherein the second case is made of a thermoplastic resin that is more flexible than the first case; and
wherein the stationary terminal is secured to the second case through a receiving hole which is positioned in an inside bottom portion of the first case.

2. A switch device according to claim 1, wherein the first case and the cover conceal the stationary contact and the movable contact.

3. A switch device according to claim 1, further comprising preventing means aligning the first case to the second case.

4. A switch device according to claim 3, wherein the preventing means comprises a recess positioned on the outside surface of the first case, and a protrusion positioned on an inside surface of the second case.

5. A switch device according to claim 1, further comprising a protruding step projecting from an inside bottom surface of the second case disposed near a hole within the second case configured to receive the stationary terminal, and a through hole, passing through an inside bottom portion of the first case, the through hole being configured to receive the protruding step, wherein the bottom surface portion of the stationary terminal is in contact with the projecting step.

6. A switch device according to claim 5, wherein the first case and the second case are coupled by passing the protruding step through the through hole.
